(19) United States
(12) Patent Application Publication
(10) Pub. No.: US 2026/0149693 A1
(43) Pub. Date: May 28, 2026

(54) Efficient Packet Capture for Cyber Threat Analysis

(71) Applicant: Centripetal Networks, LLC, Portsmouth, NH (US)

(72) Inventors: David K. Ahn, Winston-Salem, NC (US); Sean Moore, Hollis, NH (US)

(21) Appl. No.: 19/254,454

(22) Filed: Jun. 30, 2025

Related U.S. Application Data
(63) Continuation of application No. 18/210,896, filed on Jun. 16, 2023, now Pat. No. 12,375,447.
Application No. 18/210,896 is a continuation of application No. 15/382,806, filed on Dec. 19, 2016, now Pat. No. 11,729,144.
(60) Provisional application No. 62/274,541, filed on Jan. 4, 2016.

(51) Int. Cl. H04L 9/40

(52) U.S. Cl. CPC H04L 63/0236; H04L 63/0263; H04L 63/1408; H04L 63/1425; H04L 63/20

(57) ABSTRACT

Methods, systems, and computer-readable media for efficiently detecting threat incidents for cyber threat analysis are described herein. In various embodiments, a computing device, which may be located at a boundary between a protected network associated with the enterprise and an unprotected network, may combine one or more threat indicators received from one or more threat intelligence providers; may generate one or more packet capture and packet filtering rules based on the combined threat indicators; and, may capture or filter, on a packet-by-packet basis, at least one packet based on the generated rules. In other embodiments, a computing device may generate a packet capture file comprising raw packet content and corresponding threat context information, wherein the threat context information may comprise a filtering rule and an associated threat indicator that caused the packet to be captured.

### CROSS REFERENCE TO RELATED APPLICATIONS

This application is a continuation of U.S. patent Ser. No. 18/210,896 , filed Jun. 16, 2023, which is a continuation of U.S. patent Ser. No. 15/382,806 , filed Dec. 19, 2016, which claims priority to U.S. provisional application Ser. No. 62/274,541, filed Jan. 4, 2016, entitled “EFFICIENT PACKET CAPTURE FOR CYBER THREAT ANALYSIS,” which is herein incorporated by reference in its entirety for all purposes.

### FIELD

Aspects described herein generally relate to computer hardware and software and network security. In particular, one or more aspects of the disclosure generally relate to computer hardware and software for capturing network packets for cyber threat analysis.

### BACKGROUND

Many enterprises (e.g., corporations, partnerships, governments, academic institutions, other organizations, etc.) find it challenging to protect their networks from cyber-attack. Packet capture is a fundamental tool for cyber-analysts who are investigating potential threat incidents. However, conventional packet capture solutions are very inefficient and expensive, both in terms of capital expenditures and operating costs, and are unable to operate at the scale and dynamics of the Internet cyber threat when used for threat analysis. To complicate matters further, most of the captured packets are never used in the threat analysis process.

For example, to detect threat incidents, a typical conventional threat detection system will configure its packet filtering devices, e.g., network firewalls, web proxies, router access control lists (ACLs)), to log all or log a subsample of packet transit events, and store the logs on disk. This configuration will capture threat incidents but will also capture many legitimate (non-threat) events. Typically, threat traffic constitutes only a small percentage of network traffic, so the inefficiency factors are on the order of 10X-100X. That is, the fidelity of threat incidents in the log files is very low. Furthermore, the raw logs do not discriminate between threat incidents and legitimate events. To identify threat incidents in the logs, cyber-analysts typically download recent threat intelligence (often called “Indicators-of-Compromise (IoCs)”, or “threat indicators”, or “indicators” within proper context) from their preferred threat intelligence provider(s), and then search the logs for matches with the indicators. Each search is usually performed against one indicator at a time. Given that threat intelligence providers typically supply 10,000 to 1,000,000 indicators per day, it is not a surprise that the average times-to-discovery of network attacks are measured in weeks or months (if they are ever discovered).

Conventional packet capture solutions have similar inefficiencies for threat management, and for similar reasons. The motivation for capturing packets is that the cyber-analyst who is investigating threat incidents may want to view the contents of the packets that generated a particular threat incident log. Because conventional solutions cannot readily discriminate between threat and legitimate packets when they are in transit, the default behavior is to capture all, or substantially all, packets. Capturing or storing all packets ensures that when a cyber-analyst wants to investigate a threat incident by examining the associated packets'contents, the associated packets will be in store. However the cost is high: As above with packet logs, given that threat communications typically compose only a small percentage of network traffic, the inefficiencies are very large, with 10X-100X more packets stored than will be needed for threat analysis.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards systems, methods, and techniques for efficiently detecting threat incidents for cyber threat analysis. In particular, aspects described herein provide a purpose-built packet filter configured to efficiently detect threat incidents as the associated packets cross the network's boundary/security perimeter. Aspects of the disclosure described in greater detail below may be used to aggregate threat indicators supplied by many different threat intelligence providers, and compare these threat indicators to each packet that is transiting the network boundary/security perimeter. Additional aspects of the disclosure may be used to integrate threat filtering, threat incident logging, and threat packet capture to facilitate filtering, logging, and capture using the same threat indicators at the same time at the same network location. Other features may be used to capture bidirectional flows if or when most of the packets in the flow do not match an indicator rule. Features described in greater detail below may be used to include threat context information in packet capture files for cyber threat analysis.

In accordance with one or more embodiments, a method, for using threat intelligence to effect packet capture in an enterprise threat management system, may comprise receiving, by a computing device, one or more threat indicators from one or more threat intelligence providers, wherein the computing device is located at a boundary between a protected network associated with the enterprise and an unprotected network; in response to receiving the threat indicators, combining the threat indicators based on a source address and port, a destination address and port, and a protocol type (“5-tuple”) associated with the threat indicators; generating one or more packet capture and packet filtering rules based on the combined threat indicators; and filtering, by the computing device, on a packet-by-packet basis, at least one packet based on at least one of the one or more capture and packet filtering rules. In other embodiments, the combining of the threat indicators may be based on a hostname or a fully-qualified domain name (FQDN). In yet other embodiments, the combining of the threat indicators may be based on a uniform resource identifier (URI).

In some embodiments, the method may further comprise: determining whether to log the at least one packet based on the at least one of the one or more capture and packet filtering rules; and determining whether to capture the at least one packet based on the at least one of the one or more capture and packet filtering rules. In other embodiments, wherein the filtering of the at least one packet, the determining whether to log the at least one packet, and the determining whether to capture the at least one packet is performed simultaneously.

In other embodiments, the method wherein the determining whether to capture the at least one packet based on the at least one of the one or more capture and packet filtering rules, comprises: capturing both incoming and outgoing packets comprised by a bidirectional communication flow indicated by the at least one packet.

Alternatively, in yet other embodiments, a method may comprise generating, by a computing device, a packet capture file comprising raw packet content and threat context information; wherein the threat context information comprises a filtering rule and associated threat indicator that caused the packet to be captured.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative high-level functional diagram of an end-to-end threat management system that may be used in accordance with one or more illustrative aspects described herein.

FIG. 2 depicts an illustrative system architecture that may be used in accordance with one or more illustrative aspects described herein.

FIG. 3 depicts an example event sequence for providing a method of packet filtering and capture for cyber threat analysis in accordance with one or more illustrative aspects described herein.

FIG. 4 depicts an illustrative file structure that may be used in accordance with one or more illustrative aspects described herein.

FIG. 5 depicts an illustrative file structure that may be used in accordance with one or more illustrative aspects described herein.

FIGS. 6A-6B depicts an embodiment of threat context information in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards systems, methods, and techniques for efficiently detecting threat incidents for cyber threat analysis. In particular, aspects described herein provide a purpose-built packet filter configured to efficiently detect threat incidents as the associated packets cross the network's boundary/security perimeter. Features described in greater detail below may be used to aggregate threat indicators supplied by many different threat intelligence providers, and compare these threat indicators to each packet that is transiting the network boundary/security perimeter. Additional aspects of the disclosure may be used to integrate threat filtering, threat incident logging, and threat packet capture to facilitate filtering, logging, and capture using the same threat indicators at the same time at the same network location. Other features may be used to capture bidirectional flows if or when most of the packets in the flow do not match an indicator rule. Features described in greater detail below may be used to include threat context information in packet capture files for cyber threat analysis.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

### End-to-End Threat Management System

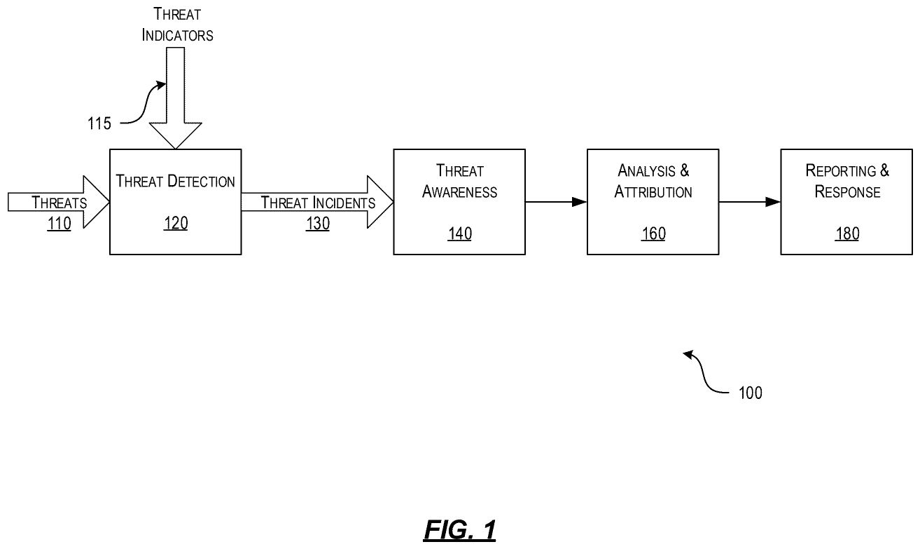

FIG. 1 illustrates one example of an end-to-end threat management system 100. The input to the threat management system 100 may consist of threats 110, which may be in the form of IP protocol or other packets comprising the various network communication flows crossing the boundaries of an enterprise network. In the network, these threat packets 110 may be mixed with non-threat packets generated by legitimate communications.

The threat detection module 120 may be configured to identify, or discriminate, the threat packets 110 from among the legitimate packets. Once identified, the threat detection module 120 may generate or create threat incidents 130 based on the identified threat packets 110. For example, the threat detection module 120 may compute logs of the threat packets 110. Threat incidents 130 are the input into the next functional stage, the threat awareness module 140.

Note that packet logs produced by packet filtering devices typically include Layer 2 to Layer 7 header information and environmental/context information, such as time-of-day, ingress/egress interface name, etc., but do not include the entire raw packet. The raw packet is typically not included in logs for several reasons, including space and processing resource requirements, and because the individual logs of the packets that compose a flow are often compressed into a single log of the associated flow. The flow is typically at the level of abstraction at which cyber-analysts and network administrators perform their monitoring and analysis functions. Thus, in network traffic monitoring and analysis, packet capture is generally considered to be a function that is separate and distinct from packet or flow logging.

The threat detection module 120 may be further configured to aggregate threat indicators 115 from one or more threat intelligence providers and to use these threat indicators 115 to identify threat incidents 130. For example, a type of threat indicator 115 may comprise one or more network addresses indicating one or more websites that are known to be operated by cyber criminals or other malicious actors, or that display characteristics and behavior indicative of malicious operation. Communications between a known malicious website and a host attached to an enterprise network may be a component of an attack on the enterprise network. The threat detection module 120 may compare and match the network addresses used in the network communications with the threat indicators 115 provided by the threat intelligence providers. In some embodiments, the network address may comprise an Internet Protocol (IP) address. In other embodiments, the network address may comprise a uniform resource identifier (URI) address. In yet other embodiments, the network address may comprise hostnames or fully-qualified domain names (FQDN). Other types of threat indicators 115 may comprise identification of a X.509 certificate or of a certificate authority. An example of such a threat detection module 120 is the RULEGATE packet filter appliance offered for sale by Centripetal Networks, Inc., of Leesburg, VA. See U.S. Pat. No. 9,137,205, entitled “Methods and Systems for Protecting a Secured Network,” hereby incorporated by reference, for additional details of a packet security gateway such as the RULEGATE packet filter appliance.

The threat awareness module 140 may be configured to provide cyber-analysts with situational awareness of the threats/potential attacks against the network. The threat awareness module 140 may aggregate packet logs and threat incidents 130 into flow logs, and may also perform flow correlations and risk scoring. The threat awareness module 140 may associate flows from both sides of a flow-transforming device, such as firewalls or web proxies, which are segments of the same communication. A flow, or a microflow, may refer to a collection of packets with the same “5-tuple” values (i.e., source address and port, a destination address and port, and a protocol type) generated by the same (single) event/action at the sourcing host. In some cases, the bidirectional flow may be identified as the flow, i.e., the packets flowing between the source and destination in both directions. The packets composing a bidirectional flow may have the same 5-tuple values, but may have the source and destination field values transposed depending on the direction of the packet (e.g., from client-to-server, or from server-to-client).

The threat awareness module 140 may be further configured to compute a threat risk score for a threat incident 130. A higher computed risk score may indicate a higher likelihood that the corresponding threat incident 130 is an actual attack. After processing, the threat awareness module 140 may present the threat incidents 130 to a cyber-analyst or other approved user, and may also provide situational awareness of the identified threats 110, or potential attacks, against the network. An example of such a threat awareness module is the QUICKTHREAT application offered for sale by Centripetal Networks, Inc., of Leesburg, VA. See U.S. patent application Ser. No. 14/690,302, entitled “Rule-Based Network-Threat Detection,” hereby incorporated by reference, for additional details.

The analysis & attribution module 160 may determine if a threat incident 130 is an actual attack, and if so, may attribute the attack to one or more malicious actors. The analysis & attribution module 160 may fuse multiple sources of data associated with the threat incident 130 to determine if the threat incident 130 is an actual attack. The multiple sources of data being fused may include the contents of packets associated with the threat incidents, threat intelligence reports, threat incident context, correlations, and the like. The functions provided by the analysis & attribution module 160 may be performed using software such as an expert system or other types of artificial intelligence. In the alternative, a human cyber-analyst may perform such functions using conventional techniques. In another alternative, the expert system or other type of artificial intelligence may assist a human cyber-analyst to perform the analysis & attribution functions.

The report & response module 180 may be configured to report on attacks and their effects, and specify response actions, if any. Response actions may include blocking communications with attack sites, removing malware-infected hosts, or otherwise compromised hosts, from the protected network, and sweeping malware-infected hosts that were victims of attacks or unwitting participants/abettors in attacks. The functions provided by the report & response module 180 may be performed using software such as an expert system or other types of artificial intelligence. In some embodiments, a human cyber-analyst may perform such functions using conventional techniques. In other embodiments, the expert system or other type of artificial intelligence may assist a human cyber-analyst to perform the analysis & attribution functions. In yet other embodiments, the enterprise may subscribe to a service which may produce attack reports with recommended response actions. An example of such a service is the Network Threat Assessment and Monitoring service offered by Centripetal Networks, Inc., of Leesburg, VA.

FIG. 1 illustrates just one example of a system architecture that may be used, and those of skill in the art will appreciate that the specific system architecture and computing devices used may vary, and are secondary to the functionality that they provide, as further described herein. For example, the functionality provided by the threat detection module 120, threat awareness module 140, analysis & attribution module 160, and the reporting & response module 180 may be combined or separated into a different combination of modules. Similarly, the functionality provided by these modules may be implemented using a combination of computing hardware and software components, and humans-in-the-loop (e.g., cyber-analysts). For example, these modules may be executed on a single computing device or on multiple computing devices at one site or distributed across multiple sites and interconnected by a communication network.

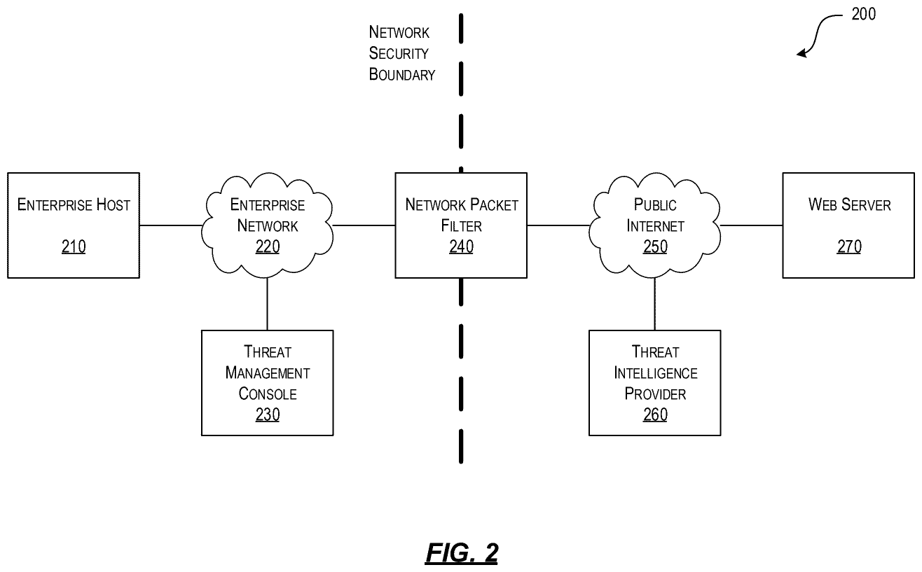

FIG. 2 depicts an illustrative system architecture which may be used for packet capture for cyber threat analysis in accordance with one or more example embodiments. As seen in FIG. 2, a network packet filter 240 may be placed at a network security boundary between the protected enterprise network 220 and the public Internet 250 in order to have visibility of all outgoing and incoming traffic between the enterprise (protected) network 220 and the public (unprotected) Internet 250. In one embodiment, the network packet filter 240 may be placed at or near an Internet access link provided by the enterprise's Internet service provider (ISP.) The network packet filter 240 may provide functionality similar to the functionality provided by the threat detection module 120 described above in reference to FIG. 1. The network packet filter 240 may be configured to filter, log, and capture packets that match filtering rules that have been generated from threat indicators 115 provided by one or more threat intelligence providers 260. In some embodiments, the network packet filter 240 may combine threat indicators 115 based on the “5-tuple” values (i.e., the protocol type, source address and port, destination address and port) associated with the threat indicators 115. In other embodiments, the network packet filter 240 may combine the threat indicators based on a hostname or a fully-qualified domain name (FQDN) comprised by the threat indicators 115. In yet other embodiments, the network packet filter 240 may combine the threat indicators based on a uniform resource identifier (URI) associated with the threat indicators 115. The network packet filter 240 may support rules written using the extended rule syntax described in further detail in the next section below. See U.S. Pat. No. 9,137,205, entitled “Methods and Systems for Protecting a Secured Network,” hereby incorporated by reference, for additional details of a packet security gateway, e.g., a network packet filter.

Referring to FIG. 2, the threat intelligence provider 260 may provide a threat intelligence subscription service which may be configured to deliver threat indicators to the network packet filter 240. The network packet filter 240 may be subscribed to one or more threat intelligence providers 260. An enterprise may find it advantageous to subscribe to multiple threat intelligence providers 260 because providers often specialize in certain types of threat intelligence. For example, one threat intelligence provider may focus on supplying intelligence and indicators for botnet command & control (C&C) servers, whereas another provider may focus on phishing web sites/URLs, whereas yet another provider may focus on malware delivered through advertising feeds. However, providers may prefer to be a sole source for their subscribers, so they may broaden their coverage by including other types of intelligence/indicators, possibly gleaned from open sources available to all providers. As a result, there may be a significant probability that multiple providers may provide overlapping threat indicators. The network packet filter 240 may combine multiple threat indicators into fewer indicators or into a different set of threat indicators in order to reduce the number of filtering rules and reduce the potential for duplicate rules, inconsistent rules, or gaps in rule coverage.

A threat management console 230 may be a computing device configured to host one or more threat management applications and may be operated by an enterprise cyber-analyst and may assist the cyber-analyst in managing and executing the functionality described above in reference to FIG. 1 (see FIG. 1, elements 120, 140, and 160). The threat management console 230 may be configured to control and monitor operation of the network packet filter 240, as well as, to receive threat incidents, packet logs, and other situational awareness from the network packet filter 240. The threat management console 230 may also be configured to control and monitor operation of the threat intelligence information services supplied by threat intelligence providers 260. The threat management console 230 may be further configured to manage the rules and threat intelligence used by the network packet filter 240 to filter and capture packets. The threat management console 230 may also manage threat incidents, threat awareness, and threat analysis and reporting as described above in reference to threat awareness module 140 and to analysis & attribution module 160. The threat management console 230 may be hosted on a single server or on a multiple-server or virtualization system (e.g., a remote access or cloud system) configured to provide virtual machines for the threat management applications. In some embodiments, the threat management applications may be implemented as web applications and accessed through a web browser.

Referring to FIG. 2, the computing environment 200 may include a web server 270. In some embodiments, the web server 270 may be operated by a cybercriminal group, and may be hosted at a commercial hosting service.

Computing environment 200 also may include one or more enterprise hosts 210. Enterprise hosts 210 may be any type of computing device capable of receiving and processing input via one or more user interfaces, providing output via one or more user interfaces and communicating input, output, and/or other information to and/or from one or more other computing devices. For example, enterprise host 210 may be a server computer, a desktop computer, laptop computer, tablet computer, smart phone, or the like. One or more enterprise hosts 210 may become infected by malware beaconing out or exfiltrating to web server 270, or may be operated by an enterprise user that may be knowingly or unknowingly communicating with web server 270.

Computing environment 200 also may include one or more networks, which may interconnect the network packet filter 240, the threat management console 230, and the enterprise hosts 210. For example, computing environment 200 may include enterprise network 220, which may include one or more private networks operated by and/or associated with the enterprise and which may include one or more local area networks, wide area networks, virtual private networks, etc.

FIG. 2 illustrates just one example of a system architecture that may be used, and those of skill in the art will appreciate that the specific system architecture and computing devices used may vary, and are secondary to the functionality that they provide, as further described herein. For example, the services provided by the network packet filter 240 may be executed on a single computing device or on multiple computing devices at one site or distributed across multiple sites and interconnected by a communication network.

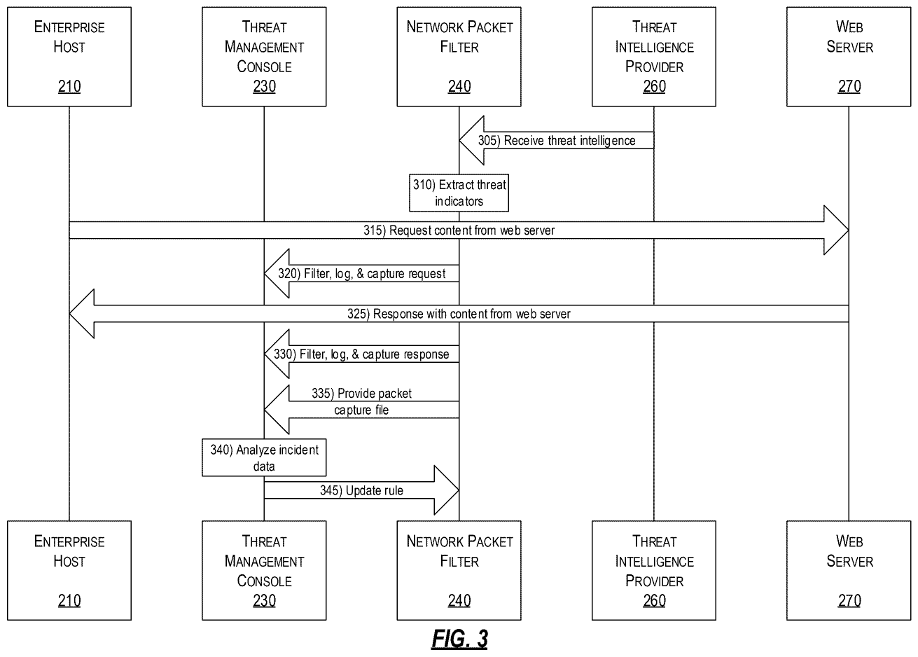

FIG. 3 depicts an example event sequence that illustrates a method of packet filtering and capture for cyber threat analysis. As seen in FIG. 3, one or more steps of the depicted example event sequence and other similar examples described herein may be performed in a computing environment such as the system illustrated in FIG. 2, as well as other systems having different architectures. In other embodiments, the method illustrated in FIG. 3 and/or one or more steps thereof may be embodied in a computer-readable medium, such as a non-transitory computer readable memory.

In step 305, the network packet filter 240 may receive threat intelligence feeds from one or more threat intelligence providers 260. The network packet filter 240 may aggregate all the received threat intelligence feeds from the one or more threat intelligence providers 260 into a single threat intelligence feed. At step 310, the network packet filter 240 may extract the threat indicators from the threat intelligence feeds. The threat indicators may comprise network addresses, X.509 certificates, or certificate authorities. The network packet filter 240 may be configured to create a packet filtering rule for each threat indicator and include the newly created filtering rule in the filter's active network security policy. In some embodiments, the packet filtering rule may include a “log” directive and a “pcap” directive. The “log” directive may cause the network packet filter 240 to create a log of a packet, a threat incident, that matches the associated rule. The “pcap” directive may cause the network packet filter 240 to create a copy of a packet matching the associated rule and capture/store the packet on local storage in the network packet filter 240.

In step 315, the enterprise host 210 may request to retrieve content from web server 270. In some embodiments, the content request may originate from a web browser or a malware application executing within the enterprise host 210. In other embodiments, the request may comprise a HTTP GET request. For example, HTTP “GET www.risky-site.com” may be used to retrieve the default resource (e.g., the home page) from the web server associated with domain name www.risky-site.com.

In step 320, the network packet filter 240 may filter the content request from the enterprise host 210 as it is transmitted through the network packet filter 240 to its destination, the web server 270. The network packet filter 240 may be configured to compare the request packet with all of the rules in its active network security policy. In some embodiments, the request packet may match a rule such as:
pass in log pcap quick from any to any host www.risky-site.com

The “log” directive in the rule for the example embodiment may cause the network packet filter 240 to create a log of the request packet, or threat incident, and store it on a local disk in the log file. In some embodiments, the log data may be formatted using the Common Event Format (CEF) (publicly-available open-source format). The network packet filter 240 may also push the threat incident to the threat management console 230 to alert a cyber-analyst to the threat incident. The threat incident may be assigned a high risk score based on the current risk scoring factors and criteria. See U.S. patent application Ser. No. 14/690,302, entitled “Rule-Based Network-Threat Detection,” hereby incorporated by reference, for additional details of risk scoring factors and criteria. The “pcap” directive in the rule for the example embodiment may cause the network packet filter 240 to store a copy of the request packet in a file, using libpcap format (publicly-available open-source library) or pcap-ng format (publicly-available open-source library), on a local disk. The “pcap” directive may also cause the network packet filter 240 to collect threat context information associated with the requested packet and store it with the copy of the request packet.

In step 325, the web server 270 may return the requested content in response to the request sent in step 315. The one or more packets comprising the response may be routed through the network packet filter 240 to the enterprise host 210. In step 330, the network packet filter 240 may filter, log, and capture the response from the web server 270.

In step 335, the threat management console 230 may obtain, from the network packet filter 240, a file comprising the one or more packets associated with the threat incident. In some embodiments, the requested file may be formatted in standard libpcap or pcap-ng formats.

In step 340, the threat management console 230 may present the threat incidents using the available dashboard instruments. See U.S. patent application Ser. No. 14/690,302, entitled “Rule-Based Network-Threat Detection,” hereby incorporated by reference, for additional details of dashboard instruments. The threat management console 230 may be configured to present the threat incident associated with the request in step 315 at or near the top of a dashboard instrument if the threat incident has a high risk score. The threat management console 230 may prioritize high risk threat incidents and alert the cyber-analyst to the most serious threats or potential attacks. The threat management console 230 may include packet analyzer tools to review the full content of the packets associated with the threat incident. The threat management console 230 may be further configured to fuse and collate the threat intelligence data, threat incident data, packet content data, threat context data, and additional situational awareness information.

In step 345, the threat management console 230 may update the packet filtering rules associated with the threat incident based on the results of the threat incident investigation. For example, the threat management console 230 may request the network packet filter 240 to block packets associated with the threat incident. In response, the network packet filter 240 may update one or more rules and update its active security policy.

Advantageously, and as illustrated in greater detail above, the network packet filter 240 may use threat intelligence to select only threat packets that are crossing the security boundary for logging and capture functions. In addition, integrating packet logging and packet capture with each packet filtering rule may improve threat-packet-capture efficiency by using the same threat indicators at the same location at the same time. Under typical enterprise network conditions, this results in large increases in efficiency for space and computing resources. Furthermore, it also reduces the time needed for the cyber-analyst to determine the type and nature of a threat, while improving the quality of the determination, e.g., to reduce false positives and false negatives.

### Packet Capture Extensions to Packet Filtering Rules

A de facto standard syntax for filtering rules used by many packet filtering devices is the syntax for rules in PF and/or IPFilter, which are packet filtering/firewall software. PF was developed for OpenBSD in 2001 as a replacement for IPFilter (which also uses a similar rule syntax). However, the PF rule syntax does not include any directives for capturing packets. As described above, the network packet filter 240 may support packet capture by extending the PF rule syntax to include directives for capturing packets.

The PF rule syntax supports filtering on “5-tuple” field values (i.e., the protocol type, source address and port, destination address and port). The PF rule syntax extensions described herein may also support filtering on 5-tuple field values but in addition may also support filtering based on host domain names and based on uniform resource identifiers (URI).

The PF rule syntax may also be extended to include a packet capture directive that may cause the packet capture filter 240 to store a copy of any rule-matching packet to local storage. The packet capture directive may be named “pcap”. In some embodiments, the packet capture file may be formatted using either libpcap or pcap-ng formats. For example, the following packet filtering rule:
pass in log pcap quick from any to any host www.risky-site.com

may detect and capture the packet containing the “GET www.risky-site.com” request. However, it will not detect (or capture) the subsequent packets in the bidirectional flow, because none of those packets contain the value www.risky-site.com in any packet header field.

The PF rule syntax may be further extended to include a flow capture directive that may cause the network packet filter 240 to store a copy of any rule-matching packet to local storage and to also store any subsequent packets in the bidirectional flow between the web client and the web server. The flow capture directive may cause the capture of all the packets in the forward flow (client to server) and in the reverse flow (server to client). The flow capture directive may support TCP/IP packet-based protocols that comprise bidirectional flows (e.g., HTTP, SSH, SMTP, etc.) The flow capture directive may be named “fcap”. In some embodiments, the flow capture file may be formatted using either libpcap or pcap-ng formats. For example, the following packet filtering rule:
pass in log fcap quick from any to any host www.risky-site.com
has a “pass” action, which allows any matching packets to continue towards their destinations, and which enables capture of the subsequent bidirectional flows. However, if the action were “block”, then the fcap directive should not be used, instead the pcap directive should be used, as follows:
block in log pcap quick from any to any host www.risky-site.com

The pcap directive may be preferable because the original GET command would be blocked from reaching its destination and thus there may not be subsequent flow packets in response.

### Threat Context Information for Analysis of Captured Packets

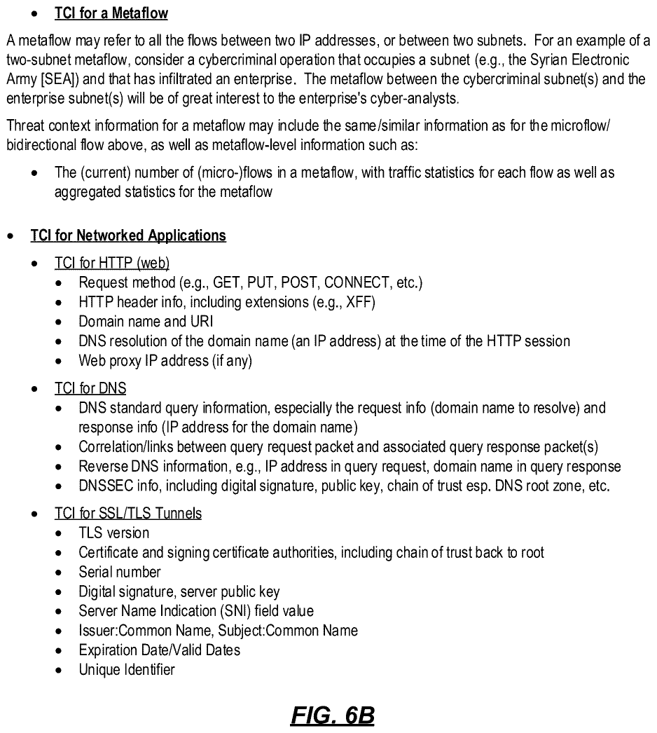

The network packet filter 240 may include threat context information (TCI), as shown in FIGS. 6A-6B, in the packet capture or flow capture files generated in response to the pcap and fcap directives, respectively. The threat management console 230 may use the threat context information included in the packet capture files in analysis of threat incidents. The threat management console 230 may be further configured to present the threat context information to the cyber-analyst reviewing and analyzing the threat incidents.

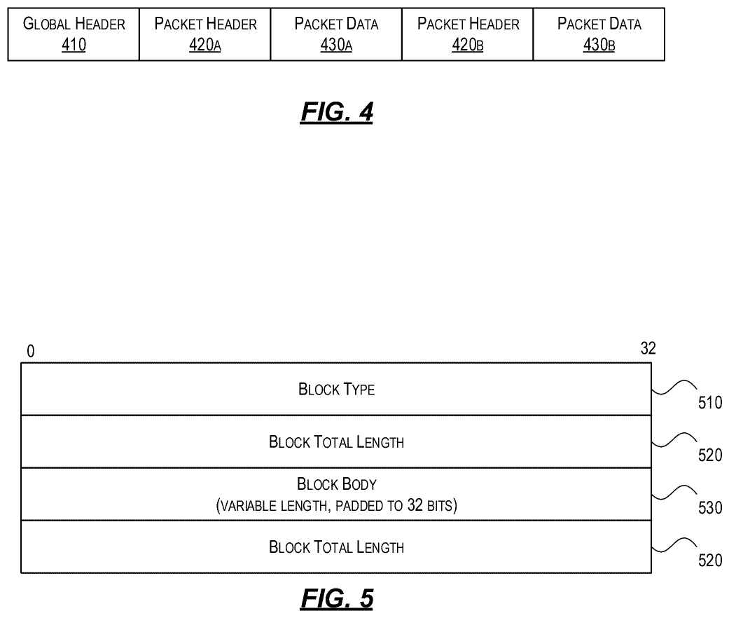

The threat context information in the packet capture files may be stored in either libpcap or pcap-ng compliant formats. The libpcap file structure, as shown in FIG. 4, comprises one global header block 410, one or more packet header blocks 420A-N, and one or more packet data blocks 430A-N. Since the libpcap file structure does not currently support an extension mechanism by which to add the threat context information, the network packet filter 240 may be configured to synthesize packets, or create “artificial” packets, in conformance with the IEEE 802a-2003 standard “Amendment 1: Ethertypes for Prototype and Vendor-Specific Protocol Development”. The synthesized packets may be in the form of Ethernet frames, with payloads containing the threat context information in the packet data blocks 430. Thus, IEEE 802a-2003 compliant devices and applications may be able to access and manipulate the threat context information as they would other packet data. Compliant devices and applications may also forward the threat context information packets through an Ethernet-switched network. For example, threat context information may be streamed to network-attached storage devices, e.g., storage array in a data center.

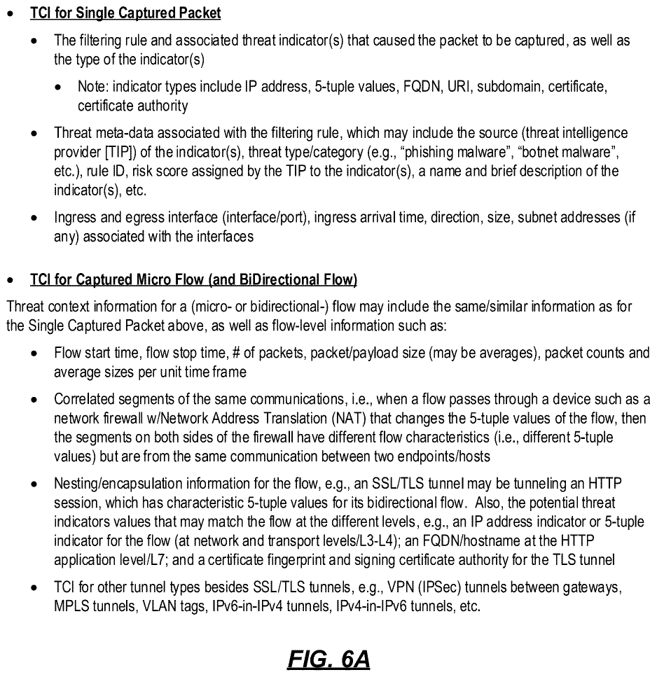

The pcap-ng file format, as shown in FIG. 5, comprises a block type 510, a block total length 520, and a block body 530 of variable length. A pcap-ng-formatted file comprises a collection of these blocks. The block type 510 field may be used to indicate the type of content in the block body 530. A pcap-ng-formatted file may comprise one of several optional or experimental block types. Among the optional block types, there are two designated for capturing packets: Simple Packet Block type and Enhanced Packet Block type. However, neither of these two optional block types may be designated for storing threat context information. The network packet filter 240 may be configured to create an experimental block type which comprises the threat context information.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order and that one or more illustrated steps may be optional. Any and all features in the following claims may be combined or rearranged in any way possible.

1. A computing device located at a boundary between a protected network and an unprotected network external to the protected network, the computing device comprising:
one or more processors; and
memory storing instructions that, when executed by the one or more processors, cause the computing device to:
receive, from one or more network threat intelligence providers external to the protected network:
a domain name, and
an Internet Protocol (IP) address;
generate one or more packet filtering rules by:
generating a first packet filtering rule configured to filter packets matching the domain name and the IP address; and
assigning a flow capture directive to the first packet filtering rule, wherein the flow capture directive is configured to cause the computing device to:
cause storage of one or more packets matching the domain name or the IP address; and
cause storage of a bidirectional flow of packets subsequent to the one or more packets matching the domain name or the IP address;
filter, based on the first packet filtering rule, a plurality of packets;
determine, based on the filtered plurality of packets, one or more first packets, received by the computing device and corresponding to a first packet flow, that comprise:
a domain name value, and
a destination address;
based on determining that the domain name value in at least one of the one or more first packets corresponds to the domain name and the destination address in the one or more first packets corresponds to the IP address, capture, based on the flow capture directive of the first packet filtering rule, the one or more first packets;
after capturing the one or more first packets, capture, based on the flow capture directive of the first packet filtering rule, one or more subsequent packets of the first packet flow; and
generate, for the captured one or more subsequent packets of the first packet flow, a packet capture file comprising:
raw packet content of the captured one or more first packets and the one or more subsequent packets, and
threat context information comprising an indication of the first packet filtering rule.

2. The computing device of claim 1, wherein the instructions, when executed by the one or more processors, cause the computing device to capture the one or more subsequent packets based on a 5-tuple of the one or more subsequent packets.

3. The computing device of claim 1, wherein the flow capture directive is configured to cause storage of all packets transiting in either direction of the bidirectional flow.

4. The computing device of claim 1, wherein the first packet filtering rule comprises a network threat indicator corresponding to the domain name and one or more second domain names, and wherein the instructions, when executed, cause the computing device to determine that the domain name value in the one or more first packets corresponds to the one or more second domain names by comparing the domain name value to the network threat indicator.

5. The computing device of claim 1, wherein the first packet filtering rule prevents packets matching the domain name and the IP address from crossing the boundary between the protected network and the unprotected network.

6. The computing device of claim 1, wherein the instructions, when executed by the one or more processors, cause the computing device to:
determine whether to log the one or more subsequent packets based on the first packet filtering rule.

7. The computing device of claim 1, wherein the first packet filtering rule permits packets matching the domain name and the IP address to cross the boundary between the protected network and the unprotected network.

8. The computing device of claim 1, wherein the assigning the flow capture directive to the first packet filtering rule is based on determining that the first packet filtering rule is configured to permit packets matching the domain name and the IP address to cross the boundary between the protected network and the unprotected network.

9. The computing device of claim 1, wherein the assigning the flow capture directive to the first packet filtering rule is based on an indication, from the one or more network threat intelligence providers, that traffic matching the domain name and the IP address should be permitted to cross the boundary between the protected network and the unprotected network.

10. A method comprising:
receiving, by a computing device located at a boundary between a protected network and an unprotected network external to the protected network and from one or more network threat intelligence providers external to the protected network:
a domain name, and
an Internet Protocol (IP) address;
generating one or more packet filtering rules by:
generating a first packet filtering rule configured to filter packets matching the domain name and the IP address; and
assigning a flow capture directive to the first packet filtering rule, wherein the flow capture directive is configured to cause the computing device to:
cause storage of one or more packets matching the domain name or the IP address; and
cause storage of a bidirectional flow of packets subsequent to the one or more packets matching the domain name or the IP address;
filtering, based on the first packet filtering rule, a plurality of packets;
determining, based on the filtered plurality of packets, one or more first packets, received by the computing device and corresponding to a first packet flow, that comprise:
a domain name value, and
a destination address;
based on determining that the domain name value in at least one of the one or more first packets corresponds to the domain name and the destination address in the one or more first packets corresponds to the IP address, capturing, based on the flow capture directive of the first packet filtering rule, the one or more first packets;
after capturing the one or more first packets, capturing, based on the flow capture directive of the first packet filtering rule, one or more subsequent packets of the first packet flow; and
generating, for the captured one or more subsequent packets of the first packet flow, a packet capture file comprising:
raw packet content of the captured one or more first packets and the one or more subsequent packets, and
threat context information comprising an indication of the first packet filtering rule.

11. The method of claim 10, wherein the capturing the one or more subsequent packets is based on a 5-tuple of the one or more subsequent packets.

12. The method of claim 10, wherein the flow capture directive is configured to cause storage of all packets transiting in either direction of the bidirectional flow.

13. The method of claim 10, wherein the first packet filtering rule comprises a network threat indicator corresponding to the domain name and one or more second domain names, and wherein the determining that the domain name value in the one or more first packets corresponds to the one or more second domain names comprises comparing the domain name value to the network threat indicator.

14. The method of claim 10, wherein the first packet filtering rule prevents packets matching the domain name and the IP address from crossing the boundary between the protected network and the unprotected network.

15. The method of claim 10, further comprising:
determining whether to log the one or more subsequent packets based on the first packet filtering rule.

16. One or more non-transitory computer-readable media storing instructions that, when executed by one or more processors of a computing device located at a boundary between a protected network and an unprotected network external to the protected network, cause the computing device to:
receive, from one or more network threat intelligence providers external to the protected network:
a domain name, and
an Internet Protocol (IP) address;
generate one or more packet filtering rules by:
generating a first packet filtering rule configured to filter packets matching the domain name and the IP address; and
assigning a flow capture directive to the first packet filtering rule, wherein the flow capture directive is configured to cause the computing device to:
cause storage of one or more packets matching the domain name or the IP address; and
cause storage of a bidirectional flow of packets subsequent to the one or more packets matching the domain name or the IP address;
filter, based on the first packet filtering rule, a plurality of packets;
determine, based on the filtered plurality of packets, one or more first packets, received by the computing device and corresponding to a first packet flow, that comprise:
a domain name value, and
a destination address;
based on determining that the domain name value in at least one of the one or more first packets corresponds to the domain name and the destination address in the one or more first packets corresponds to the IP address, capture, based on the flow capture directive of the first packet filtering rule, the one or more first packets;
after capturing the one or more first packets, capture, based on the flow capture directive of the first packet filtering rule, one or more subsequent packets of the first packet flow; and
generate, for the captured one or more subsequent packets of the first packet flow, a packet capture file comprising:
raw packet content of the captured one or more first packets and the one or more subsequent packets, and
threat context information comprising an indication of the first packet filtering rule.

17. The one or more non-transitory computer-readable media of claim 16, wherein the instructions, when executed by the one or more processors, cause the computing device to capture the one or more subsequent packets based on a 5-tuple of the one or more subsequent packets.

18. The one or more non-transitory computer-readable media of claim 16, wherein the flow capture directive is configured to cause storage of all packets transiting in either direction of the bidirectional flow.

19. The one or more non-transitory computer-readable media of claim 16, wherein the first packet filtering rule comprises a network threat indicator corresponding to the domain name and one or more second domain names, and wherein the instructions, when executed, cause the computing device to determine that the domain name value in the one or more first packets corresponds to the one or more second domain names by comparing the domain name value to the network threat indicator.

20. The one or more non-transitory computer-readable media of claim 16, wherein the first packet filtering rule prevents packets matching the domain name and the IP address from crossing the boundary between the protected network and the unprotected network.
